(19) United States
(12) Patent Application Publication
(10) Pub. No.: US 2014/0314364 A1
(43) Pub. Date: Oct. 23, 2014

(54) ELECTRO-OPTIC MODULATOR HAVING HIGH EXTINCTION RATIO WHEN FUNCTIONING AS SWITCH

(71) Applicant: HON HAI PRECISION INDUSTRY CO., LTD., New Taipei (TW)

(72) Inventor: HSIN-SHUN HUANG, New Taipei (TW)

(21) Appl. No.: 13/945,911

(22) Filed: Jul. 19, 2013

(30) Foreign Application Priority Data
Apr. 23, 2013 (TW) 102114479

(51) Int. Cl. G02F 1/365

(52) U.S. Cl. CPC G02F 1/365
USPC 385/2

(57) ABSTRACT

An electro-optic modulator includes a substrate, a Y-shaped waveguide, and a pair of first electrodes and a pair of second electrodes. The waveguide is formed in the substrate and includes a first Y-shaped section and a second Y-shaped section. The pair of first electrodes and the pair of second electrodes are formed on the substrate and receive voltages which modulate the first and second sections such that outputs of the first and second sections are equal to each other and an improved extinction ratio is thus obtained.

### BACKGROUND

1. Technical Field

The present disclosure relates to integrated optics and, particularly, to an electro-optic modulator having a high extinction ratio when functioning as a switch.

2. Description of Related Art

Electro-optic modulators, such as Mach-Zehner electro-optic modulators, change a refractive index of a branch of a Y-shaped waveguide (hereinafter the first branch) using a modulating electric field, utilizing electro-optic effect. Thus, the modulator can alter a phase of lightwaves traversing the first branch. As a result, the lightwaves traversing the first branch have a phase shift and thus interfere with lightwaves traversing another branch of the Y-shaped waveguide (hereinafter the second branch). An output of the Y-shaped waveguide is modulated as the output depends on the phase shift, which in turn depends on the modulating electric field. However, being limited by manufacturing imprecision, powers of the lightwaves traversing the first and second branches are not equal to each other. As such, when the modulator is used as a switch, the output is often larger than zero in an off state (i.e., the phase shift is π) or less than a desired maximum value in an on state (i.e., the phase shift is zero). An extinction ratio of the switch is less than satisfactory.

Therefore, it is desirable to provide an electro-optic modulator that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an electro-optic modulator, according to an embodiment.

FIG. 2 is a cross-sectional view taken along a line II-II of FIG. 1.

### DETAILED DESCRIPTION

Embodiments of the present disclosure will be described with reference to the drawings.

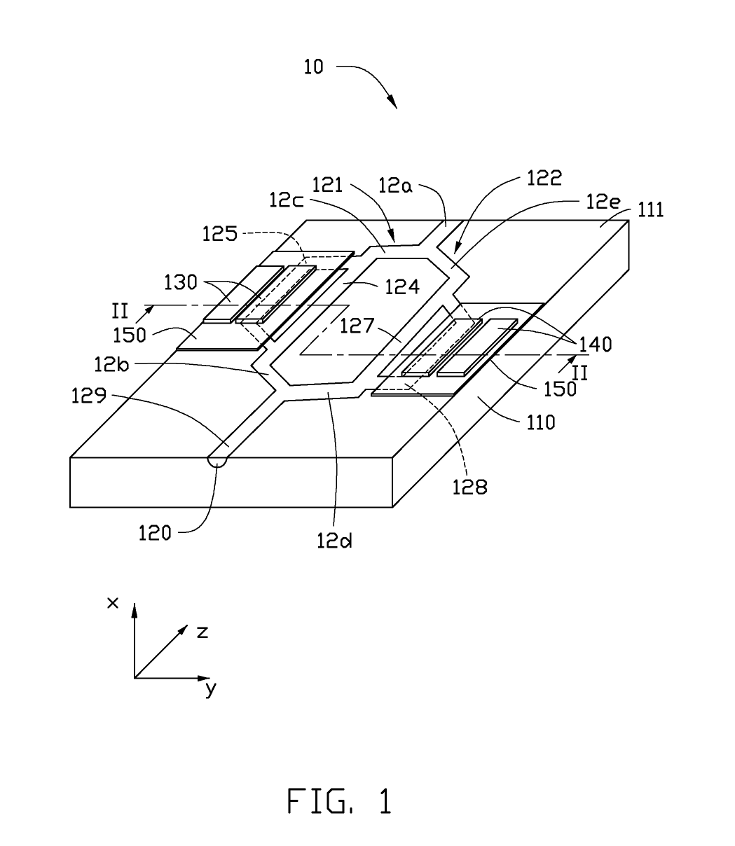

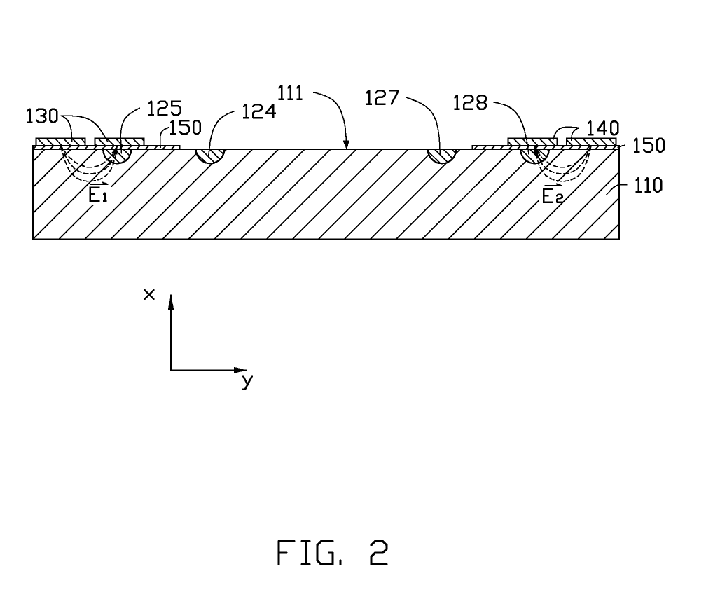

FIGS. 1 and 2 show an electro-optic modulator 10, according to an embodiment. The modulator 10 includes a substrate 110, a waveguide 120, a pair of first electrodes 130, and a pair of second electrodes 140.

The substrate 110 is made of lithium niobate (LiNbO₃) crystal to increase a bandwidth of the modulator 10, as LiNbO₃ crystal has a high response speed. In this embodiment, the substrate 110 is substantially rectangular and includes a top surface 111.

The waveguide 120 is formed by applying a layer of titanium as a coating on a shape corresponding to the waveguide 120 and diffusing the titanium into the substrate 110 by, for example, a high temperature diffusion technology. In this embodiment, the waveguide 120 is formed in the top surface 111.

The waveguide 120 is Y-shaped and formed in the substrate 110. The waveguide 120 includes a first section 121 and a second section 122. The first section 121 is Y-shaped and includes a first branch 124 and a second branch 125. The second section 122 is Y-shaped and includes a third branch 127 and a fourth branch 128.

The first to fourth branches 124, 125, 127, 128 are substantially parallel with each other and the second and fourth branches 125, 128 are located at two opposite sides of the first and third branches 125, 127.

In addition to the first section 121 and the second section 122, the waveguide 120 includes an input section 129 and an output section 12a. The first and second sections 121, 122 diverge from the input section 129 and are converged into the output section 12a.

In addition to the first branch 124 and the second branch 125, the first section 121 includes a first input branch 12b and a first output branch 12c. The first and second branches 124, 125 diverge from the first input branch 12b and are converged into the first output branch 12c.

In addition to the third branch 127 and the fourth branch 128, the second section 122 includes a second input branch 12d and a second output branch 12e. The third and fourth branches 127, 128 diverge from the second input branch 12d and are converged into the second output branch 12e.

The first electrodes 130 are strip-shaped and positioned on the substrate 110, i.e., the top surface 111. One of the first electrodes 130 covers the second branch 125 and the other is positioned at a side of the second branch 125 opposite to the first branch 124.

The second electrodes 140 are strip-shaped and positioned on the substrate 110. One of the second electrodes 140 covers the fourth branch 128 and the other is positioned at a side of the fourth branch 128 opposite to the third branch 127.

The first and second electrodes 130, 140 receive voltages applied thereto and modulate the first and second sections 121, 122 such that outputs of the first and second sections 121, 122 are equal to each other. That is, each of the first and second electrodes 130, 140 and the corresponding first electrodes 130 or the second electrodes 140 cooperatively function as a secondary modulator.

Each first electrode 130 is configured to be parallel with and have the same length as the second branch 125. Each second electrode 140 is configured to be parallel with and have the same length as the fourth branch 128. As such, modulating electric fields [symbol] 1, [symbol] 2 generated by the first and second electrodes 130, 140 traverse the whole of second and fourth branches 125, 128 respectively.

In principle, the output of the output section 12a can be calculated by the following equation:

ae^{i(α-wt)}=a₁e^{i(φ-wt)}+a₂e^{i(β-wt)}

wherein, a, a₁, a₂ are amplitudes of lightwaves traversing the output section 12a, the first output branch 12c, and the second output branch 12e respectively, α, φ, β are phases of lightwaves traversing the output section 12a, the first output branch 12c, and the second output branch 12e respectively, and where e is the natural exponent, i is the imaginary unit, ω is an angular velocity, and t is a time variable.

The output of the output section 12a can be calculated by the following equation:

S=a²=a₁²+a₂²+2aa₂ cos(φ−β)

wherein S is the output of the output section 12a.

Similarly, the outputs of the first and second output branches 12c, 12e can be calculated by the following equations:

a₁e^{i(φ-wt)}=a₁₁e^{i(φ}^{₁}^{-wt)}+a=a₁₁e^{i(φ}^{₁}^{-wt)}+a₁₂e^{i(φ}^{₂}^{-wt)},

Q₁=a₁²=a₁₁²+a₁₂²=2a₁₁a₁₂ cos(φ₁−φ₂),

a₂e^{i(φ-wt)=}a₂₁e^{i(β}^{₁}^{-wt)}a₂₂e^{i(β}^{₂}^{-wt)}, and

Q₂=a₂²=a₂₁²+a₂₂²+2a₂₁a₂₂ cos(β₁−β₂),

wherein a₁₁, a₁₂, a₂₂, a₂₂ are amplitudes of lightwaves traversing the first to fourth branches 124, 125, 127, 128 respectively, φ₁, φ₂, β₁, β₂, are phases of lightwaves traversing the first to fourth branches 124, 125, 127, 128 respectively, and Q₁, Q₂ are the outputs of the first and second output branches 12c, 12e.

The lightwaves have transverse electric waves (hereinafter the TE mode) and transverse magnetic waves (hereinafter the TM mode). In a coordinate system xyz (see FIG. 1), wherein axis is a vertical height of the substrate 110 (i.e., perpendicular to the top surface 111), y axis is a horizontal width of substrate 110 (parallel with the top surface 111 and perpendicular to the first to fourth branches 124, 125, 127, 128), and Z axis is a crossways length of the substrate 110 (i.e., along a direction that is parallel with the first to fourth branches 124, 125, 127, 128), the TE mode has an electric field component \vec{Ey} vibrating along the Y axis only. The TM mode has an electric field component \vec{Ex} vibrating along the X axis and a \vec{Ez} vibrating along the Z axis.

As one of the first electrodes 130 covers the second branch 125, a portion of the electric field [symbol] 1 interacting with the second branch 125 is substantially parallel with the x axis, and thus efficiently modulates the TM mode (i.e. Ex) and alters the phase φ₂. Similarly, a portion of the electric field [symbol] 2 interacting with the fourth branch 128 is substantially parallel with the x axis, and thus efficiently modulates the TM mode (i.e. Ex) and alters the phase β₂.

By changing the phases φ₂, β₂, the following equations: Q₁=Q₂, and φ−β=0 (or φ−β=π) can be realized. As such, when the modulator 10 is used as a switch, the output of the waveguide 120 is zero in an off-state and substantially reaches a desired maximum value in an on state, and thus an extinction ratio of the modulator 10 is increased.

To avoid lightwaves being absorbed by the first and second electrodes 130, 140 that cover the second and fourth branches 124, 128, a buffer layer 150 is formed and sandwiched between the substrate 110 and the first and second electrodes 130, 140 that cover the second and fourth branches 124, 128. The buffer layer 150 can be made of silicon dioxide.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electro-optic modulator, comprising:
a substrate;
a Y-shaped waveguide formed in the substrate and comprising a first Y-shaped section and a second Y-shaped section, the first Y-shaped section comprising a first branch and a second branch, the second Y-shaped section comprising a third branch and a fourth branch, the first to fourth branches being substantially parallel with each other, the second and fourth branches being positioned at two opposite sides of the first and third branches;
a pair of first electrodes formed on the substrate, one of the first electrodes covering the second branch and the other first electrode positioned at a side of the second branch; and
a pair of second electrodes formed on the substrate, one of the second electrodes covering the fourth branch and the other second electrode positioned at a side of the fourth branch opposite to the first branch;
wherein the first electrodes and the second electrodes are configured to receive modulating voltages and configured to modulate the first and second sections such that outputs of the first and second sections are equal to each other.

2. The modulator of claim 1, wherein the substrate is made of lithium niobate crystal.

3. The modulator of claim 1, wherein the waveguide is made of lithium niobate crystal diffused with titanium.

4. The modulator of claim 1, wherein the waveguide comprises an input section and an output section, and the first and second sections diverge from the input section and are converged into the output section.

5. The modulator of claim 1, wherein the first section comprises a first input branch and a first output branch, and the first and second branches diverge from the first input branch and are converged into the first output branch.

6. The modulator of claim 1, wherein the second section comprises a second input branch and a second output branch, and the third and fourth branches diverge from the second input branch and are converged into the second output branch.

7. The modulator of claim 1, wherein each first electrode is configured to be parallel with and as long as the second branch.

8. The modulator of claim 1, wherein each second electrode is configured to be parallel with and as long as the fourth branch.

9. The modulator of claim 1, comprising a buffer layer formed and sandwiched between the substrate and the first and second electrodes that cover the second and fourth branches to avoid lightwaves being absorbed by the first and second electrodes that cover the second and fourth branches.

10. The modulator of claim 9, wherein the buffer layer is made of silicon dioxide.
